(19) United States
(12) Patent Application Publication
(10) Pub. No.: US 2012/0219418 A1
(43) Pub. Date: Aug. 30, 2012

(54) GPS AUTOMATED TRACKING OF MOBILE MONITORING UNITS

(75) Inventors: James Ingerslew, Sugarland, TX (US); Thomas Schubert, Fort Mill, SC (US)

(73) Assignee: SCHAEFFLER TECHNOLOGIES AG & CO. KG, Herzogenaurach (DE)

(21) Appl. No.: 13/505,579

(22) PCT Filed: Nov. 11, 2010
(86) PCT No.: PCT/EP2010/067291

§ 371 Date: May 2, 2012

Related U.S. Application Data
(60) Provisional application No. 61/261,231, filed on Nov. 13, 2009.

(51) Int. Cl. F03D 11/00

(52) U.S. Cl. 416/1

(57) ABSTRACT

A method of monitoring a wind turbine, including the steps of: attaching a condition monitoring (CM) module to a wind turbine; determining the location of the CM module based on information received at the wind turbine by the CM module; monitoring operational parameters of the wind turbine using the CM module; and transmitting the operational parameters to the central facility.

### TECHNICAL FIELD

The invention relates to wind turbines and more specifically to monitoring the operational condition of wind turbines.

### BACKGROUND OF THE INVENTION

Wind turbines are electromechanical devices used to convert wind power to electrical power. Often, wind turbines use wind to drive a gearbox, rotor shaft, and a generator (or other mechanical elements) that ultimately produces electricity. After a period of operation, the mechanical elements used by wind turbines may need to be monitored for abnormal behavior, predictive maintenance, or warranty checks. Condition monitoring (CM) equipment can be installed that provides feedback about the operational condition of the wind turbines. However, linking CM equipment to wind turbines is a labor-intensive task and involves equipment having a wide range of components. This equipment can typically include a processor, digital memory, as well as various sensors that are coupled to the wind turbine or specific components thereof. These sensors can include a speed sensor for measuring turbine speed, accelerometers for measuring vibration, and a current monitor for determining turbine load.

For CM equipment that is portable and meant to be moved from wind turbine to wind turbine, the party that monitors the CM equipment may have difficulty determining the identity and/or location of the monitored wind turbine(s). Presently, the monitoring party may receive a telephone call or other communication from the individuals who installed the CM equipment. Using that communication, the installer provides the identity and/or the location of the installed CM equipment. However, in some circumstances, the installer and the monitoring party do not closely communicate. The installer and the monitoring party may report to different companies. The installer may install equipment after traditional working hours when no monitoring employee is available. Or in some cases such a large number of wind turbines are monitored by CM equipment that the location and/or identity of the equipment becomes difficult to manage. Additionally, the records maintained by the installers can be poor. In that case, the installers may need to revisit the wind turbines on which they installed CM equipment in order to determine the identity or location of that equipment. Installation time can therefore be costly and human resources can be wasted searching for CM equipment. Furthermore, losing the data not monitored during the time the CM equipment location is unknown can be costly as well.

### SUMMARY OF THE INVENTION

In accordance with the invention, there is provided a CM system which includes one or more CM modules that can be temporarily installed on a corresponding number of wind turbines to gather data about each monitored turbine over a period of time. The equipment used in the CM system can include a remote access (RA) module for each CM module that receives the data from the CM module and wirelessly transmits it in real time to a remote monitoring (RM) station. The CM equipment includes GPS, an RFID, or some other transponder or other location-indicating capability that is used by the RM station to uniquely identify the location and identity of the monitored wind turbine. The CM equipment can determine and transmit its location without relying on the installer. Thus, the CM equipment described herein reduces human error that can occur when installers are tasked with identifying a plurality of CM equipment locations and can also increase the speed and convenience with which remote operators can determine the location of CM equipment.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 depicts a condition monitoring (CM) system for monitoring wind turbines using CM equipment and remote monitoring (RM) stations;

FIG. 2 depicts a block diagram of an embodiment of the CM equipment;

FIG. 3 depicts exemplary components of the CM equipment of FIG. 2;

FIG. 4 depicts an embodiment of a visual display used for remote monitoring of the wind turbines; and

FIG. 5 shows examples of speed sensors.

### DETAILED DESCRIPTION OF THE PREFERRED EMBODIMENTS

Wind turbines, also referred to as wind generators, wind mills, or wind energy converters, transform wind energy into electricity. By placing the wind turbines in areas having significant amounts of wind, electricity can be generated. Various wind turbine designs are possible. Wind turbines include drive shafts that connect turbine blades to a generator. As wind acts on the turbine blades, the drive shaft rotates powering the generator and creating electricity.

In general, the disclosed monitoring system and method uses condition monitoring (CM) equipment to monitor one or more wind turbines. The CM equipment for a single wind turbine can include a CM module that includes sensors for measuring turbine operational parameters and a remote access (RA) module that obtains the (processed and/or unprocessed) sensor data from the CM module and transmits it wirelessly to a central facility or other remote monitoring (RM) station. The operational parameters measured by the CM module includes metrics that can involve the mechanical/electrical health of the wind turbines. This can be done for any desired purpose, such as for predictive or preventative maintenance, or for an end of warranty check. Examples of abnormal behavior include excessive vibration generated by the driveshaft of the wind turbine or excessive current draw from the turbine.

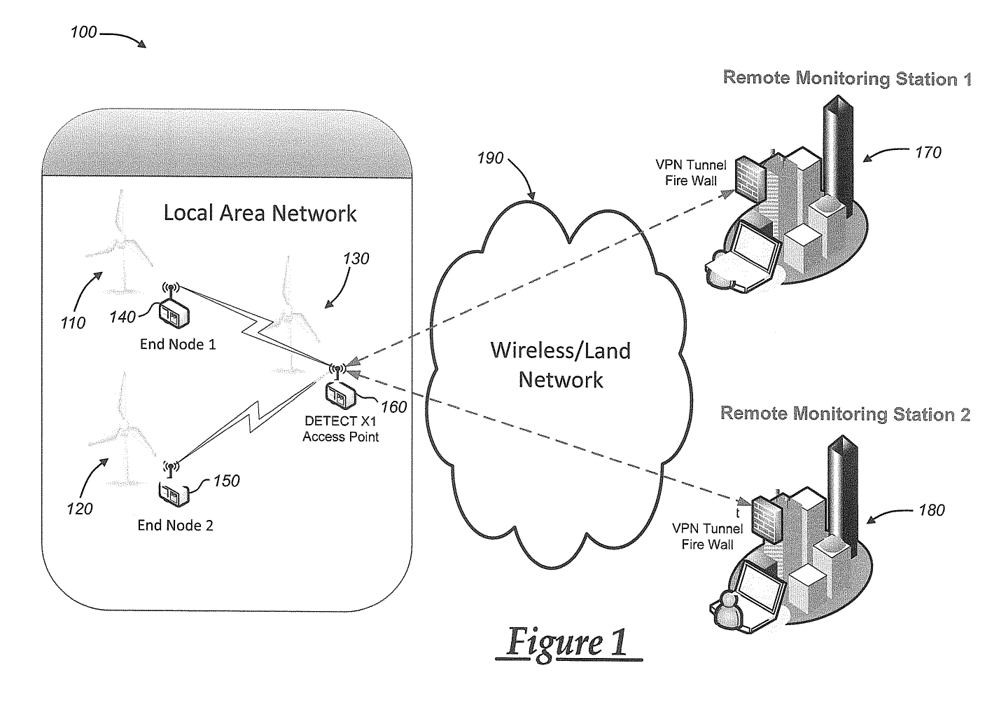

Turning to FIG. 1, there is shown an exemplary system 100 for monitoring wind turbines using the CM equipment and RM stations. The system 100 includes a plurality of wind turbines 110-130, CM equipment 140-160, a first RM station 170, a second RM station 180, and a land network/wireless network 190. The RM stations 170, 180 can be located at nearly any geographical location and communicate with the CM equipment 140-160 via the land/wireless network 190. If desired, only one RM station can be used, two or more can be used. Through the communications, the RM stations 170, 180 can obtain the data generated by the CM equipment 140-160, such as wind turbine vibration data, latitude and longitude coordinates from a GPS receiver, current draw, or temperature. And at the RM stations 170, 180, the generated data can be processed and archived for presentation to a wind turbine owner/operator.

The land network may be a conventional land-based telecommunications network that connects CM equipment 140-160 to RM stations 170, 180. The land network can also use a wireless network for a portion of the communications between a RM station and the CM equipment on any particular turbine. Both the land network and the wireless network are generally shown at 190. The wireless network can also provide communications between the CM equipment 140-160 and the RM stations 170, 180 without the land network. For example, land network may include a public switched telephone network (PSTN) such as that used to provide hardwired telephony, packet-switched data communications, and the Internet infrastructure. One or more segments of the land network could be implemented through the use of a standard wired network, a fiber or other optical network, a cable network, power lines, other wireless networks such as wireless local area networks (WLANs), or networks providing broadband wireless access (BWA), or any combination thereof. The wireless network can be a cellular telephone system that includes a plurality of cell towers, one or more mobile switching centers, as well as any other networking components required to connect the wireless network with the land network.

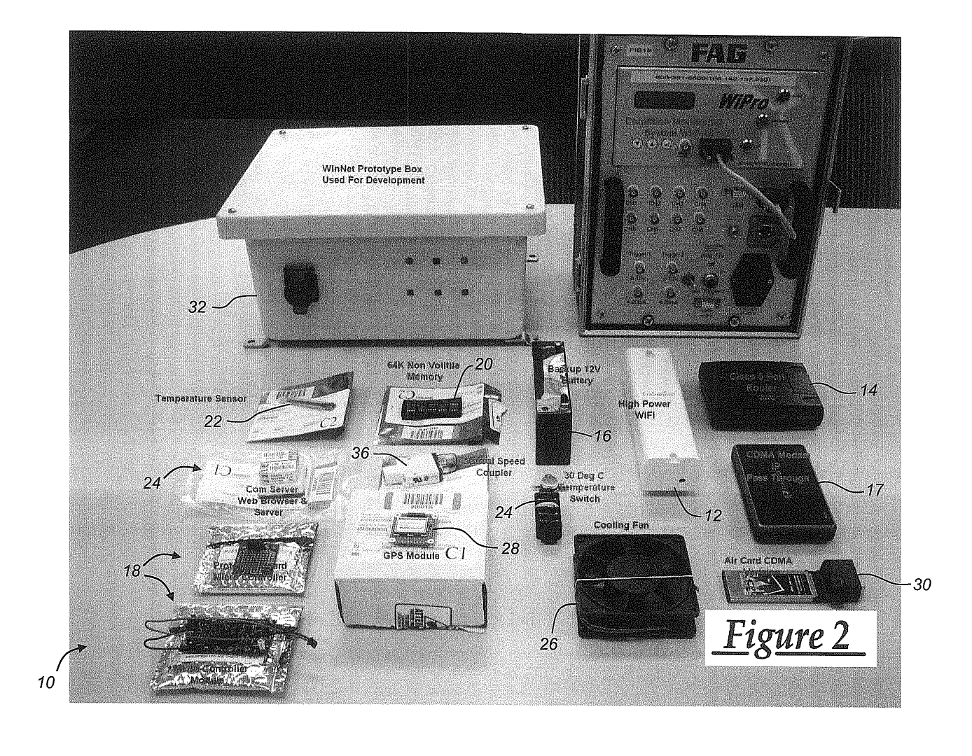

The CM equipment can monitor the wind turbines using speed sensors or other sensors that are permanently incorporated into the wind turbine or that can be incorporated into the CM equipment. As shown in FIG. 2, the CM equipment 140-160 for each turbine includes both a CM module 210 and a remote access (RA) module 240 interconnected together either wirelessly, via a hardwired connection, or by being integrated into a single enclosure or other assembly. In the illustrated embodiment, the modules 210, 240 are interconnected via a hardwired cable, such as a Cat5 cable using TCP/IP in an Ethernet LAN setup to exchange data and commands. CM module 210 generally comprises a conventional condition monitoring unit that includes as its main components a power supply 212, processor 214, memory 216, and various sensors including a turbine shaft speed sensor 218, a plurality of accelerometers 220, and a current monitor 222. The memory 216 can include ROM, RAM, NVRAM, and/or other computer readable memory and can store a control program used by the processor 214 to carry out the most if not all functions of the CM module. As will be appreciated by those skilled in the art, the power supply 212, processor 214, memory 216, speed sensor 218, accelerometers 220, and current monitor 222 can all be hardware components that are commercially available and can be interconnected and controlled via software to obtain vibration and other such acceleration data from various points or components on wind turbines. Other sensors and components can also be used. For example, in lieu of or in addition to shaft speed sensor 218, an optical pickup 224 can be used in conjunction with a turbine shaft speed sensor that is not part of the CM module, but is an existing speed sensor onboard the wind turbine to monitor the speed of the turbine drive shaft as part of wind turbine operation. The existing speed sensor can be of the type that includes a light-emitting diode (LED) that outputs light pulses with a frequency equal or proportional to the rotational speed of the turbine drive shaft. Examples of typical speed sensors are shown in FIG. 5. The speed sensor can be, for example, an inductive type that includes an M12 connector and a plurality of LEDs located on the exterior of the sensor. Alternatively, a glass fiber optic sensor or convergent-mode sensor can be used as shown in FIG. 5. These also include an indicating LED (not shown). Or, any other suitable sensor can be used that provides a detectable optical output that pulses at a rate dependent on the rotational speed of the turbine shaft. As is known, these speed sensors send an electronic signal each time the drive shaft rotates a predetermined distance and also provides a visual indication of this by pulsing the included LED. Thus, rather than including a separate speed sensor 216 as a part of the CM module 210, an optical pickup 224 can be used and positioned to detect the light pulses emitted by the LED. Each time the existing speed sensor activates the LED, the optical pickup 224 detects it and generates a signal of its own. An interface circuit 226 can then be used to filter, amplify, and condition the received pulses from the optical sensor to produce a pulse train having a pulse repetition rate that is representative of the rotational speed of the turbine shaft. In this way, the CM module 210 can determine and record shaft speed. The optical pickup 224 can be a photodiode or other suitable device that is clipped to the speed sensor or otherwise mounted in close proximity to the LED in such a way to accurately receive the light pulses.

The RA module 240 is used as a wireless access node and includes as its main components a power supply module 242, a backup power supply module 244, a Wi-Fi module 246, GPS 248, and a data logger/control module 250. Modules 242-250 can be included together within a housing that is capable of supporting and protecting them from damage. The RA module 240 can be used to provide wireless communication of the sensor data from CM module 210 back to one or both remote monitor (RM) stations 170, 180. The power supply module 242 includes a power supply 243, which is sized in order to be capable of providing electrical power to all of the components of the RA module 240. This power supply module 242 can also include a Reboot function on a fixed timer such as a watchdog timer. In the event that the power supply module 242 cannot provide power to the RA module 240, the backup power supply module 244 includes a battery backup power supply 252 that can supply power to the components of the module 240. As will be appreciated by those skilled in the art, where CM module 210 and RA module 240 are hardwired together as shown, or integrated into a single enclosure, a single power supply (with or without backup) can be used in lieu of the multiple supplies shown.

The Wi-Fi module 246 includes devices capable of sending and receiving data to and from the RA module 240. The module 246 includes a Wi-Fi transceiver 256, a cellular modem 258, cellular transceiver 260, and a router 262. The GPS 248 can be a conventional GPS receiver that provides location-identifying information that can be transmitted back to the RM stations 170, 180 and used there to identify the location of the CM equipment and, thus, the wind turbine itself. The data logger/control module 250 can include a processor and memory and can be connected to the other modules 242-248 to control operation of the RA module 240 as well as log and/or forward at least some of the sensor data.

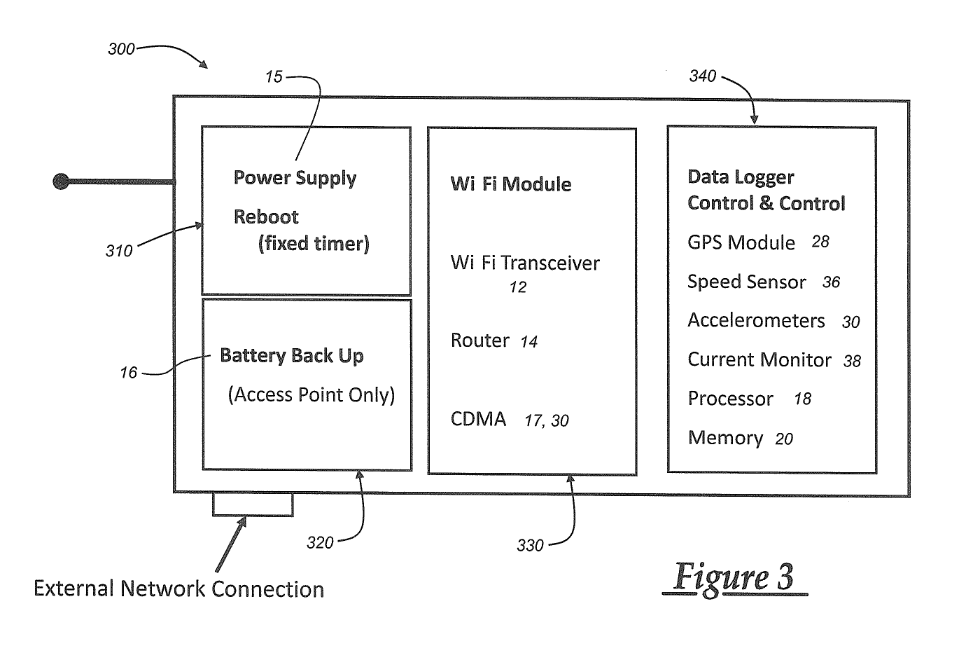

FIG. 3 depicts an exemplary set of CM equipment 160 that includes the CM module 210 and the RA module 240. Most of the various components of the RA module 240 are shown individually. Other components used in the prototype module 240 shown including a com server 266 that provides remote TCP/IP access via, for example, http to configure the CM equipment from the RM stations.

Apart from RA module 240 containing all the components shown in FIGS. 2 and 3, it can be constructed as a secondary node that has only short range wireless capability (e.g., Bluetooth or 802.11) to one or more other RA modules, at least one of which has the cellular modem/transceiver and/or other longer distance (e.g., Wi-Fi, satellite telephone, etc.) communication capability. Thus, for example, as shown in FIG. 1, when a plurality of CM equipment 140-160 are attached to a corresponding plurality of wind turbines, a main RA module 240 can be designated to act as a main or primary node and the RA modules used in the other CM equipment 140, 150 can be designated to act as secondary (end) nodes. Then, in use, data is sent from the end nodes 140, 150 to the main access node 160 which then sends it on to the RM station 170 or 180. Control and other communications from the RM station(s) can likewise be sent to the end nodes 140, 150 via the access node 160. While complicating the communication slightly, this approach eliminates the requirement that each RA module have long range communication capability. Where a particular RA module is used as a secondary node, it can omit not only the cellular communication devices, but also some of the other components of RA module 240, such as the battery backup.

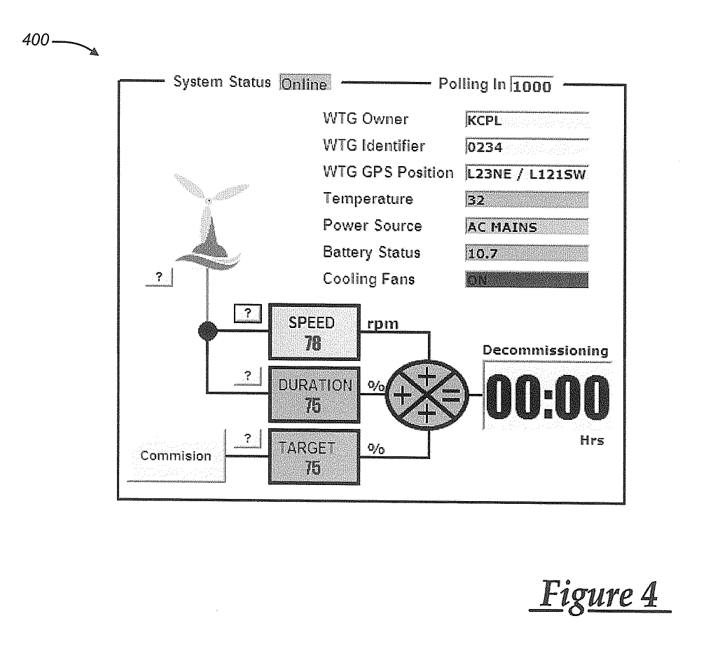

Turning to FIG. 4, the data obtained from the monitored wind turbine can be shown on a visual display 400. FIG. 4 depicts an exemplary graphical user interface generated by software on a computer at the RM stations 170, 180. Each wind turbine can have a data logger screen showing the speed of the turbine, location, communication status, and battery condition. This allows the monitoring manager to know when a new turbine comes on line and what the operating parameters are at all times. In this example, the visual display can indicate a wind turbine owner (in this example ‘KCPL’), a wind turbine identifier (‘0234’), a GPS position of the wind turbine (‘L23NE/L121SW’), a temperature (‘32’), a power source (‘AC MAINS’), a battery status (‘10.7’), and a status of the CM module cooling fan. Other metrics and data are shown and it should be appreciated that the data shown can be added to or subtracted from depending on the desires of monitoring technicians.

Software at the CM modules and at the remote station can be used to automatically report and display the location information each time the CM equipment is powered up or accessed by a technician from the RM station. A Commissioning button can be included on the user interface as shown in FIG. 4 such that, once activated, the condition monitoring and data logging begins and can be carried on for a desired length of time. A decommissioning clock indicates when the monitoring is scheduled to end, at which point the CM equipment can be removed from the wind turbine and used for subsequent monitoring of another wind turbine. As will be appreciated, as long as the CM equipment is online and in communication with the remote station, the display of FIG. 4 can be made available for review anytime by the technician at the remote station.

The collected data can include location information generated by the GPS receiver module 248. For instance, the GPS receiver module 248 can calculate the location of the CM equipment 160 based on data obtained from available GPS satellites orbiting above it. The calculation can be generated in the form of latitude and longitude coordinates. The location of the CM equipment 160 can be transmitted to a central facility, such as one or both of the RM stations 170, 180. The location of the CM equipment 160 can be associated with the wind turbine that the equipment 160 is monitoring. While the GPS receiver module 248 can calculate position of the CM equipment 160 and/or the wind turbine it monitors at any time, some events can be coupled with a calculation and transmission of the location. In one example, the CM equipment 160 directs the GPS receiver module 248 to calculate the equipment location each time the equipment is switched from a non-powered state to a powered state. After the GPS receiver module 248 calculates the location, the CM equipment 160 then transmits that location, via Wi-Fi transceiver 256 or cellular transceiver 260 to the RM station.

In another example, the location of the CM equipment 160 and its monitored wind turbine can be determined using a transponder such as a radio-frequency-identification chip (RFID) or tag attached to the wind turbine. Generally, RFID chips include an integrated circuit for storing data and an antenna. For instance, wind turbines can carry an RFID chip encoded with data based on wind turbine identification information. This identification information can include the manufacturer and serial number of the wind turbine. It can also include the location of the wind turbine, such as in latitude and longitude coordinates. The CM equipment 160 can include an RFID interrogator or reader (not shown) that uses an RF transceiver to read data from RFIDs detected within its interrogation field. When the CM equipment 160 is installed at the monitored wind turbine, the RFID interrogator accesses the data from the RFID chip carried by the monitored wind turbine. Using the accessed data, the CM equipment 160 can determine the identity and/or location of the monitored wind turbine and transmit the identity/location to the RM station(s). Or, the CM equipment 160 can access the data on the RFID chip and transmit that data itself to the RM station. While this example is described using the passive RFID tags, it is also possible to use other transponders, whether passive or active.

Referring back to FIG. 4, the location information determined using the GPS 248, RFID, or otherwise, can be used by the RM stations to automatically associate a particular wind turbine with the monitoring equipment. Each monitored wind turbine can automatically appear on a main manager visual display by GPS position (or based on RF tag location determination) prompting a technician to acknowledge its presence. It should be appreciated that visual display can also include a geographical map depicting the position(s) of the monitored wind turbine(s).

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, where the CM module and RA modules are maintained in separate enclosures, the various components can be housed differently than as shown. As one example, the GPS module 248 could be incorporated into the CM module 210 instead of the RA module 240. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of monitoring a wind turbine, comprising the steps of:
attaching a condition monitoring (CM) equipment to a wind turbine;
determining the location of the CM equipment based on information received at the wind turbine by the CM equipment;
monitoring operational parameters of the wind turbine using the CM equipment; and
transmitting the operational parameters to a central facility.

2. The method of claim 1, wherein the CM equipment includes a GPS receiver and wherein the determining step further comprises determining the location using the GPS receiver.

3. The method of claim 2, further comprising the step of transmitting location information received from the GPS receiver to the central facility.

4. The method of claim 1, wherein the wind turbine includes a transponder uniquely identifying the wind turbine and wherein the CM equipment includes an interrogator, and wherein the determining step further comprises obtaining data from the transponder using the interrogator.

5. The method of claim 4, wherein the transponder comprises an RFID tag.

6. The method of claim 1, wherein the determining step is carried out at the CM equipment and the location is then transmitted to the central facility.

7. The method of claim 1, wherein the determining step is carried out at the central facility.
